(19) United States
(12) Patent Application Publication
(10) Pub. No.: US 2006/0107563 A1
(43) Pub. Date: May 25, 2006

(54) Re-attachable container identifiers

(76) Inventors: Donald Farmsworth, Oakland, CA (US); John Nava, Ojai, CA (US); Marc E. Hankin, Los Angeles, CA (US); Jill Wild, Berkeley, CA (US)

Correspondence Address: MARC E. HANKIN, ESQ., 11414 THURSTON CIRCLE, LOS ANGELES, CA, 90049, US

(21) Appl. No.: 11/256,545

(22) Filed: Oct. 21, 2005

(30) Foreign Application Priority Data
Oct. 13, 2004 (WO) PCT/US04/33717

(51) Int. Cl. G09F 3/00

(52) U.S. Cl. 40/324; 40/310

(57) ABSTRACT

This invention is a product for identifying substances transferred into smaller containers from a larger container by using removable labels that are packaged along with the larger container's labels. The invention allows one to identify the substance once it is transferred into a smaller container and/or distinguish among smaller containers into which the same substance is poured. Several embodiments of the invention are particularly suited to the practice of wine tasting, where it is important to identify the wine poured into a glass as well as distinguish between the glasses of different tasters.

### FIELD OF INVENTION

This invention relates, generally, to container labels; more particularly to container labels that are removable and re-attachable to assist in identifying the source of a material once distributed from a larger container into a smaller unlabeled container and/or labels that serve to distinguish among multiple smaller unlabeled containers containing the said material.

### BACKGROUND

The practice of wine tasting often involves the sampling of numerous producers, types, and vintages of wine in comparison with one another. Ordinarily, the taster is presented with the varieties of wine in a series of glasses, commonly referred to as a flight. Because the wines presented to the taster in the individual glasses are poured from different wine bottles, a problem of identifying the source of a specific glass's wine often arises. This problem is commonly solved by placing the glasses in a specific order, which is committed to memory, or by placing handwritten labels underneath each glass. Each of these solutions presents its own difficulties because one's recollection of the wine type can be impaired by the social activities or inebriation that often accompany wine tasting. Also, handwritten labels are cumbersome, unsightly, and can become easily misplaced or stained in the course of the wine tasting.

Further, when wines are poured into different glasses for different tasters at social functions, the problem arises of identifying which glass belongs to whom. In order to avoid the social disgrace of drinking from another's glass and the spread of germs, disposable and reusable wine glass stem labels have been developed. These “glass charms” known in the art commonly act as necklaces that attach to the wine glass stem and identify the glass's owner by name or by a unique color or design. These glass charms, however, are often expensive and/or inconvenient because they must be purchased and/or brought separately to a wine tasting.

Similar problems arise anytime a material is transferred from one source container into several, unlabeled, containers. For example, chemists working in a laboratory can encounter similar difficulties if a container of a given compound is poured into several, smaller, unlabeled test tubes.

Therefore, there is a long-felt need in the art for a series of container labels that can be easily removed and re-affixed to the smaller containers in order to identify the source of material distributed and/or a label that distinguishes multiple containers containing the same material.

### SUMMARY OF THE INVENTION

This invention is directed towards overcoming the above problems by providing easily removable labels as part of the source container's packaging that can be affixed to smaller containers into which the material is poured. Removable labels are included with the capsule or container label on the container at the time of distribution. These labels can identify the brand, year, type, and/or any other pertinent information desired. Additionally, the individual labels on the container can be of different colors, in order to distinguish among the smaller containers onto which they are re-affixed. Upon serving or pouring the material, the labels are removed and affixed to the smaller container into which the material is distributed.

This allows each smaller container to be uniquely identified and also indicate the source of the material it contains. This is accomplished without the need for additional appurtenances such as labels or writing utensils and with a minimum of effort on the part of the server and taster.

In the practice of wine tasting, the labels can also be maintained by the taster in order to keep a record or log of wines he or she has tasted.

Other features and advantages of this invention will become apparent from the following description of several embodiments of the invention, taken in conjunction with the accompanying drawings, which illustrate, by way of example, the principles of the invention.

### BRIEF DESCRIPTION OF THE DRAWINGS

FIG. 1A is an illustration in perspective view of one embodiment of the present invention while being peeled off of a bottle.

FIG. 1B is an illustration in perspective view of one embodiment of the present invention while affixed to a glass.

FIG. 2A is an illustration in perspective view of a prior art, non-disposable wine glass label commonly referred to as a “wine charm.”

FIG. 2B is an illustration in perspective view of a prior art, disposable wine glass label.

FIG. 3A is an illustration in perspective view of another embodiment of the present invention prior to the removal of the capsule on a wine bottle.

FIG. 3B is an illustration in perspective view of another embodiment of the present invention following the removal of the capsule on a wine bottle.

FIG. 3C is an illustration in perspective view of another embodiment of the present invention while affixed to a wine glass.

FIG. 3D is an illustration in perspective view of another embodiment of the present invention after being reattached to the wine bottle, for storage.

FIG. 4 is an illustration in perspective view of another embodiment of the present invention that shows how a pull ring with cutting wire can be added to the invention for ease of operation.

FIG. 5A is an illustration in perspective view of another embodiment of the present invention prior to being removed from a wine bottle.

FIG. 5B is an illustration in detail of the back of one of the labels from one embodiment of the present invention.

FIG. 5C is an illustration in perspective view of another embodiment of the present invention while attached to a wine glass.

FIG. 6A is an illustration in perspective view of another embodiment of the present invention while on a wine bottle.

FIG. 6B is an illustration in detail of the label tab used in this same embodiment of the present invention.

FIG. 7A is an illustration of another embodiment of the present invention while being removed from a wine bottle.

FIG. 7B is an illustration of another embodiment of the present invention while being affixed onto a wine glass.

FIG. 8 is an illustration in perspective view of another embodiment of the present invention prior to being removed from a wine bottle.

FIG. 9 is an illustration in perspective view of another embodiment of the present invention prior to being removed from a wine bottle.

FIG. 10 is an illustration in perspective view of another embodiment of the present invention prior to being removed from a wine bottle.

FIG. 11A is an illustration in perspective view of another embodiment of the present invention while attached and when removed from a wine bottle.

FIG. 11B is an illustration in perspective view of another embodiment of the present invention while attached to the side of a wine glass.

FIG. 11C is an illustration of another embodiment of the present invention.

FIG. 11D is an illustration in perspective view of another embodiment of the present invention while being removed from a screw-cap type wine bottle.

FIG. 11E is an illustration in perspective view of another embodiment of the present invention while attached to the underside of a wine glass.

FIG. 12A is an illustration in perspective view of another embodiment of the present invention while attached to a box of wine.

FIG. 12B is an illustration in perspective view of another embodiment of the present invention while attached to a wine glass.

FIG. 12C is an illustration in detail of the back of one of the labels from one embodiment of the present invention.

FIG. 12D is an illustration in perspective view of another embodiment of the present invention while attached to a cup.

FIG. 13A is an illustration in perspective view of another embodiment of the present invention while attached to a box of wine.

FIG. 13B is an illustration in perspective view of the inside of the label card, another embodiment of the present invention.

FIG. 14A is an illustration in perspective view of another embodiment of the present invention while attached to a box of wine.

FIG. 14B is an illustration in perspective view of the envelope and label card of another embodiment of the present invention.

FIG. 15A is an illustration in perspective view of another embodiment of the present invention while attached to a box of wine.

FIG. 15B is an illustration of several of the varieties of label shapes that may be used in conjunction with the various embodiments of the present invention.

FIG. 16A is an illustration in perspective view of another embodiment of the present invention while attached to a box of wine.

FIG. 16B is an illustration in perspective view of another embodiment of the present invention while attached to a wine glass.

FIG. 16C is an illustration in perspective view of another embodiment of the present invention while being attached to a wine diary.

### DETAILED DESCRIPTION

In the following detailed description of various embodiments of the invention, numerous specific details are set forth in order to provide a thorough understanding of various aspects of one or more embodiments of the invention, however, one or more embodiments of the invention may be practiced without these specific details. In other instances, well-known methods, procedures, and/or components have not been described in detail so as not to unnecessarily obscure aspects of embodiments of the invention.

In the following description, certain terminology is used to describe certain features of one or more embodiments of the invention. For instance “bottle” refers to any dispenser or container used to dispense a material and “glass” includes any vessel into which an material is poured.

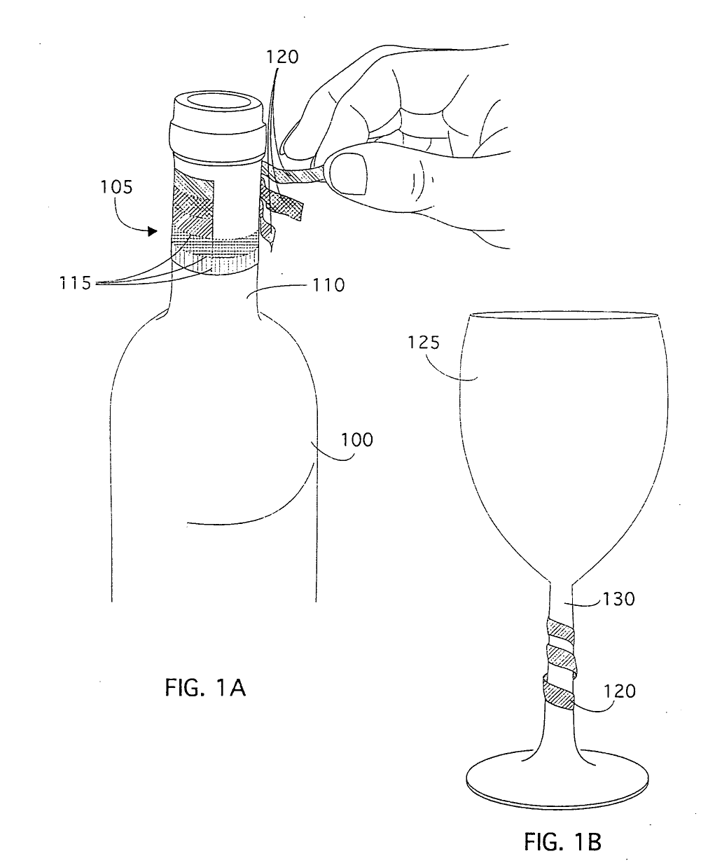

FIG. 1A is an illustration in perspective view of one embodiment of the present invention while being peeled off of a wine bottle. As show in FIG. 1A, a wine bottle 100 is packaged to include an array of re-attachable container identifiers 105 at the neck of the bottle 110, that can be concealed under the capsule or foil of the bottle or be integral to the capsule itself. The array of re-attachable container identifiers 105 is perforated 115 to allow easy removal of individual re-attachable container identifiers, 120. In this diagram, a re-attachable container identifier 120 is shown being removed from the array of re-attachable container identifiers 105 by pulling along the perforations. The re-attachable container identifiers 120 can be each colored differently, in order to allow differentiation among wine glasses, once they affixed to wine glasses Also, re-attachable container identifiers 120 can also include information about the wine itself such as producer, vintage, or type.

FIG. 1B is an illustration in perspective view of one embodiment of the present invention while affixed to a wine glass. As shown in FIG. 1B, a wine glass 125 with a wine glass stem 130 can have the re-attachable container identifier 120 affixed to it by being wrapped around the wine glass stem 130. The color coding of the re-attachable container identifier along with the text written on it allows a taster to know what wine he is drinking and to differentiate his glass among others.

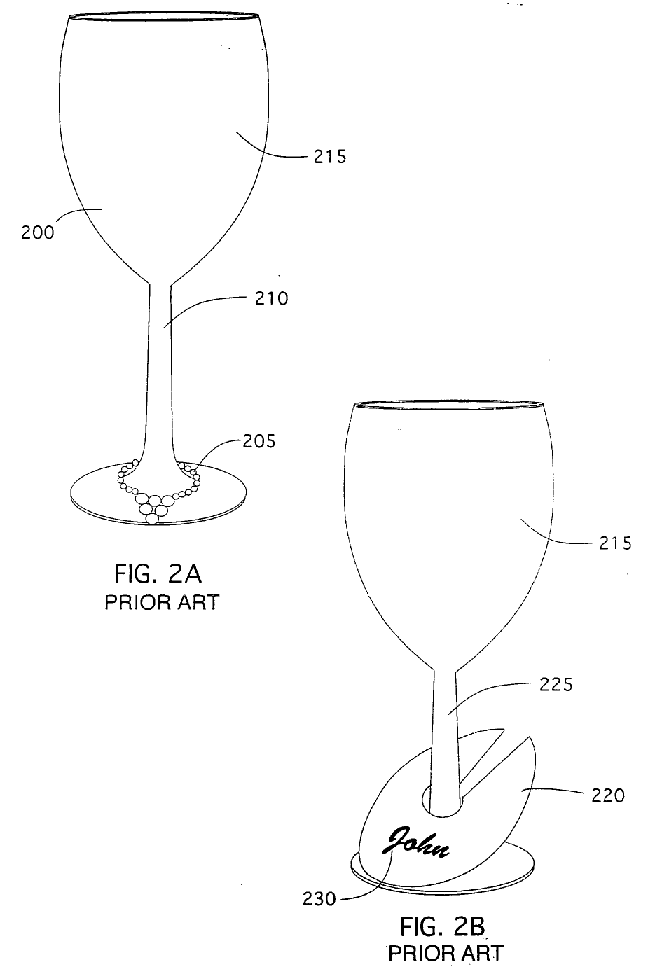

FIG. 2A is an illustration in perspective view of a prior art, non-disposable wine glass label commonly referred to as a “wine charm.” A wine glass 200 is shown with a non-disposable re-attachable container identifier 205 that acts as a necklace that is hung around the wine glass stem 210. By using differing designs and colors for the non-disposable re-attachable container identifier, they can be used to differentiate among different tasters' glasses.

FIG. 2B is an illustration in perspective view of a prior art, disposable wine glass label. As shown in FIG. 2B, a wine glass 215 is shown with a disposable wine glass label 220 that can be affixed to the wine glass stem 225 and have the name of the taster or other information written on the disposable wine glass label 230. This allows the taster to identify his or her glass and/or the type of wine in the glass.

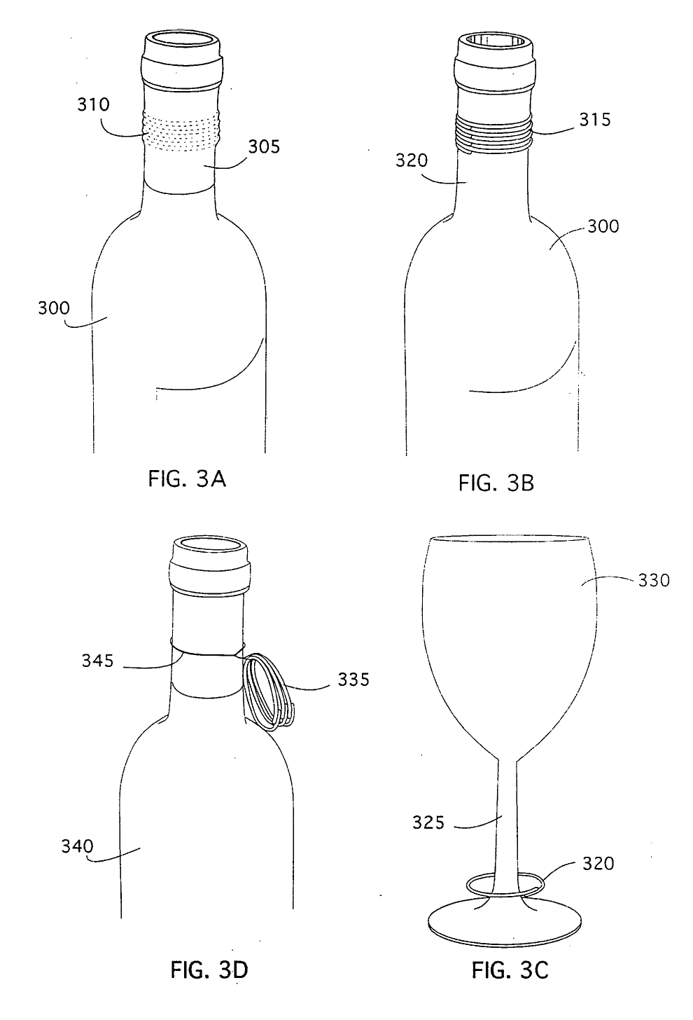

FIG. 3A is an illustration in perspective view of another embodiment of the present invention prior to the removal of the capsule on a wine bottle. As shown in FIG. 3A, a wine bottle 300 is shown with the capsule 305 not removed. The impression 310 of ring-shaped labels is visible on the capsule 305.

FIG. 3B is an illustration in perspective view of another embodiment of the present invention following to the removal of the capsule on a wine bottle. The wine bottle 300 is shown without the capsule in FIG. 3A. In this illustration, the ring-shaped labels 315 are visible as affixed on the neck of the wine bottle 320.

FIG. 3C is an illustration in perspective view of another embodiment of the present invention while affixed to a wine glass. As shown in FIG. 3C, and individual ring-shaped label 320 can be affixed to the stem 325 of a wine glass 330.

FIG. 3D is an illustration in perspective view of another embodiment of the present invention after being reattached to the wine bottle, for storage. In this illustration, ring-shaped labels 335 are attached to a wine bottle 340 using a wire or string 345.

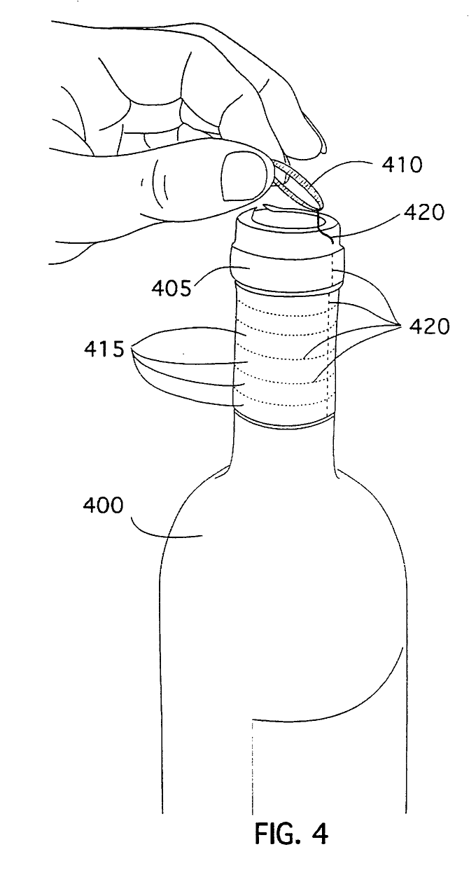

FIG. 4 is an illustration in perspective view of another embodiment of the present invention that shows how a pull ring can be added to the invention for ease of operation. A wine bottle 400 is shown with the capsule 405 not yet removed. A pull ring 410 is included with the capsule 405 to facilitate easier removal of the re-attachable container identifiers 415. The pull ring 410 is attached to a string 420 which separates the re-attachable container identifiers 415 along the perforations 420 on the capsule 405.

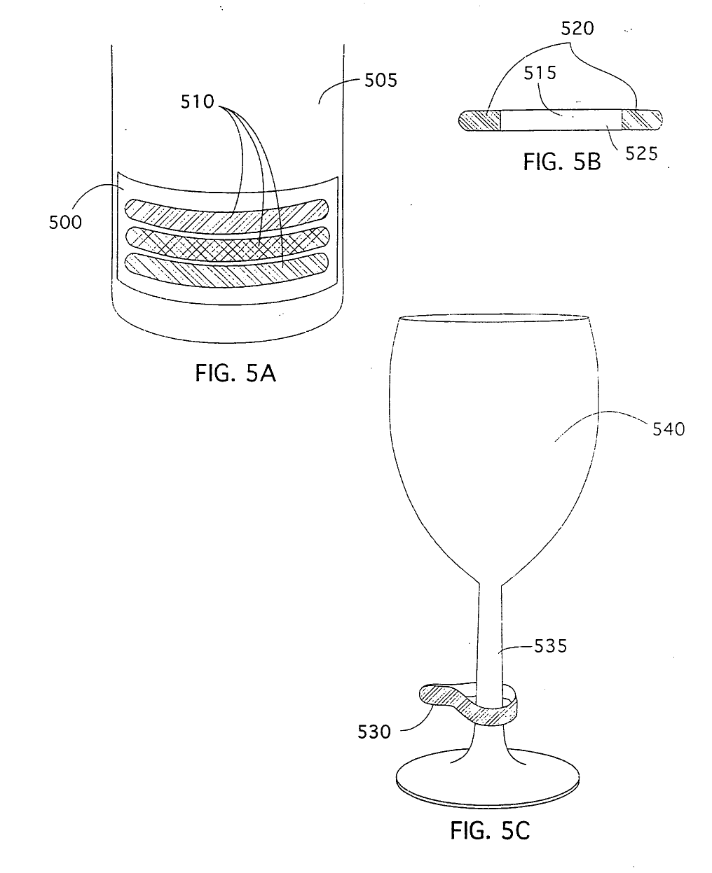

FIG. 5A is an illustration in perspective view of another embodiment of the present invention prior to being removed from a wine bottle. As shown in FIG. 5A, the back label 500 of a wine bottle 505 includes a number of removable labels 510. The labels can be printed in different colors and include information about the vineyard, type, year, or other information about the wine.

FIG. 5B is an illustration in detail of the back of one of the labels from one embodiment of the present invention. As shown in FIG. 5B, the back of a removable label 515 features two sticky portions 520 at either end of the label. The middle portion 525 of back of the label is not sticky, so as not to attach to the stem of a wine glass.

FIG. 5C is an illustration in perspective view of another embodiment of the present invention while attached to a wine glass. FIG. 5C shows a label 530 affixed to the stem 535 of a wine glass 540. The front of the label is facing outwards, allowing one to see the color of the label and any words printed thereon.

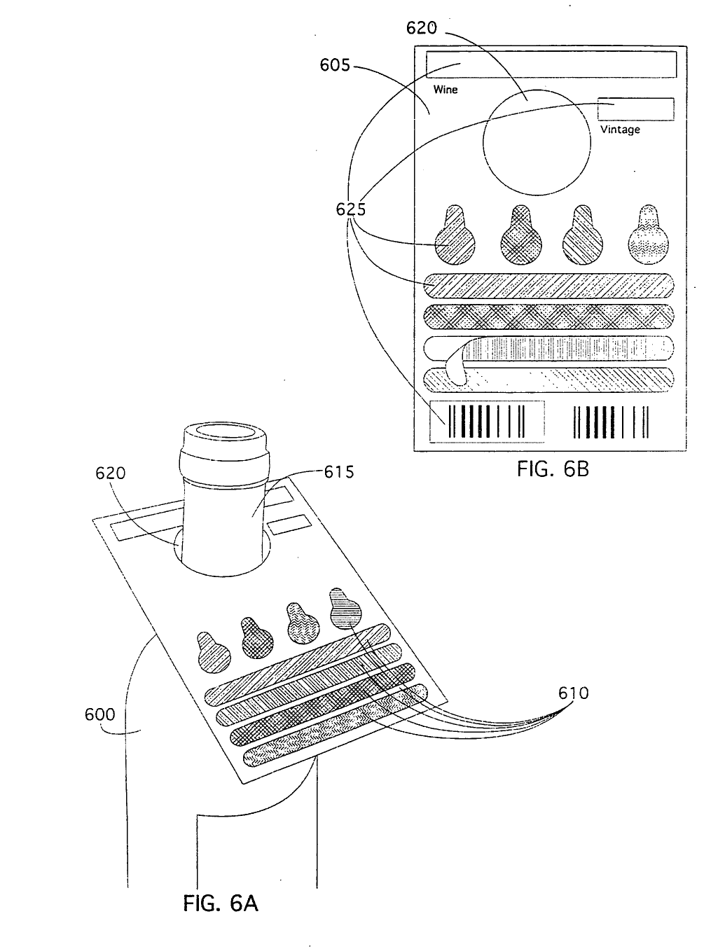

FIG. 6A is an illustration in perspective view of another embodiment of the present invention while on a wine bottle. As shown in FIG. 6A, a wine bottle 600 can hold a label card 605 containing several individual labels 610 on the neck 615 of the wine bottle 600 when the label card 605 includes a hole 620, through which the neck of a wine bottle can be inserted. The label card can operate in a similar fashion as those of other embodiments in order to designate the wine type and distinguish the taster's glass.

FIG. 6B is an illustration in detail of the label card used in this same embodiment of the present invention. As shown in FIG. 6B, a label card 605 can include several lift off labels 625 that can identify different aspects of the wine and be used to label glasses or to log the wine for future reference by the taster. Also, the label card 605 includes a hole 620 through which the neck of a wine bottle can be inserted.

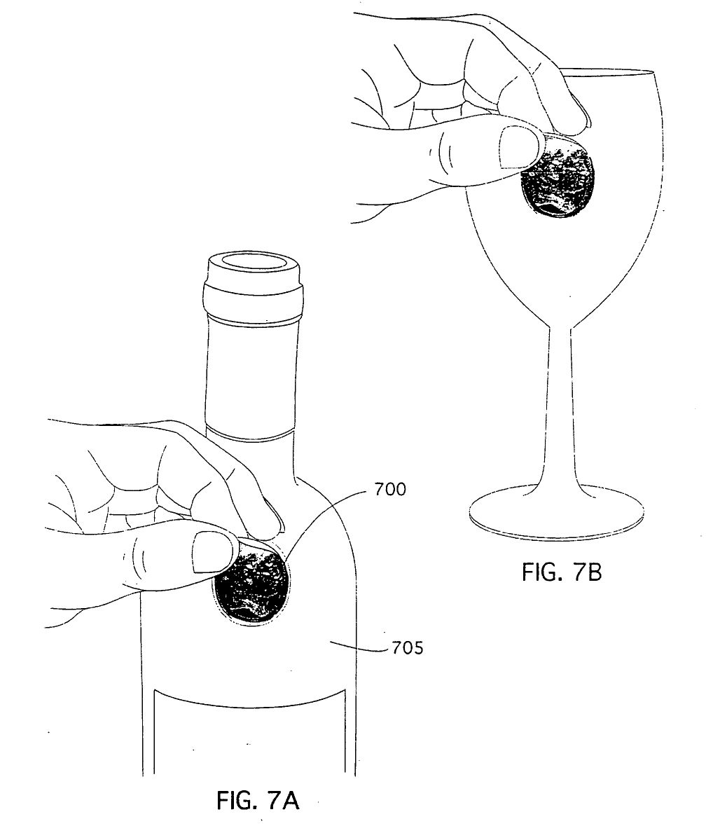

FIG. 7A is an illustration of another embodiment of the present invention while being removed from a wine bottle. As shown in FIG. 7A, a cameo 700 is being removed from a wine bottle 705. The cameo 700 can now be affixed onto a wine glass in order to identify the source of the wine poured into the glass.

FIG. 7B is an illustration of another embodiment of the present invention while being affixed onto a wine glass. A cameo 705 is being affixed to a wine glass 710 in order to identify the wine poured into the glass as coming from the wine bottle 705.

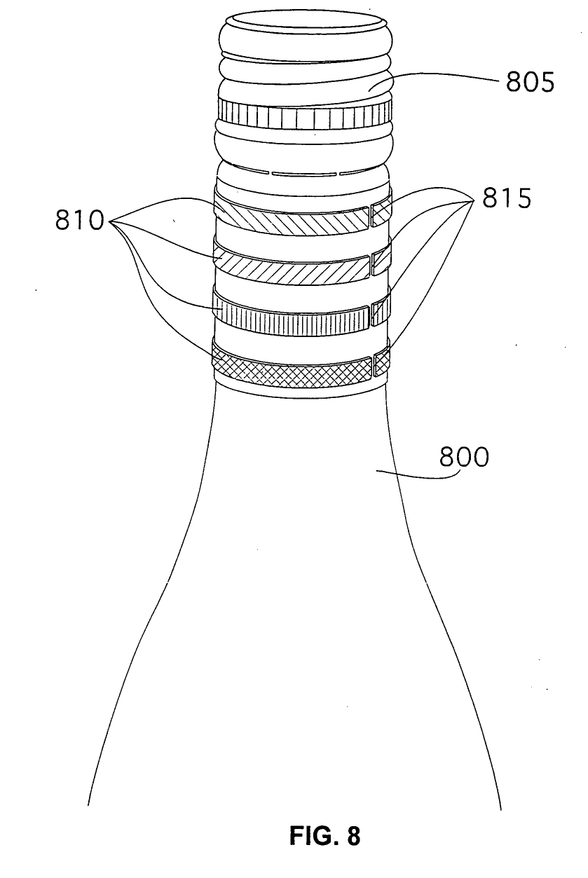

FIG. 8 is an illustration in perspective view of another embodiment of the present invention prior to being removed from a wine bottle. A wine bottle 800 is shown with a screw cap 805 and several re-attachable container identifiers 810 around the capsule of the wine bottle. The re-attachable container identifiers 810 are color coded in order to distinguish the wine glasses onto which they will be attached. The re-attachable container identifiers 815 also feature a slit 815 that allows them to be easily removed from the wine bottle 810 and re-attached to a wine glass.

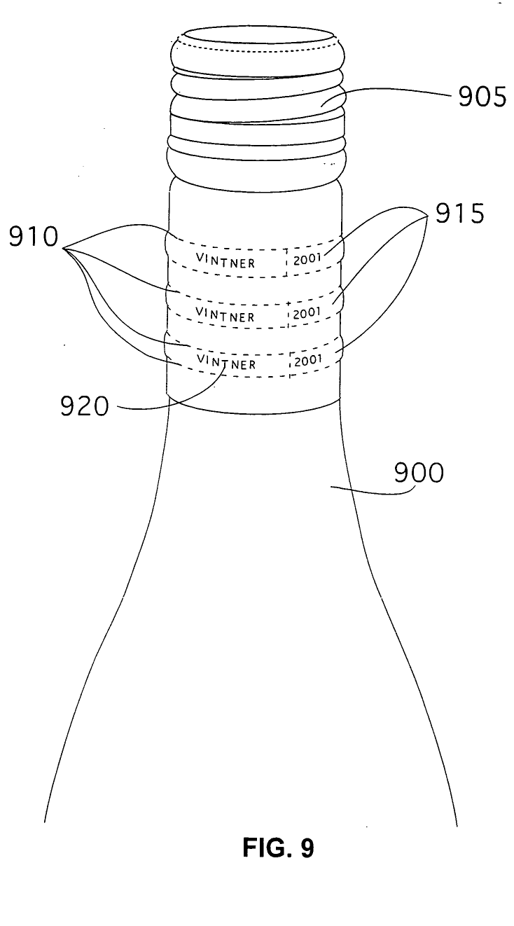

FIG. 9 is an illustration in perspective view of another embodiment of the present invention prior to being removed from a wine bottle. A wine bottle 900 is shown with a screw cap 905 and several re-attachable container identifiers 915 integrated as part of the capsule of the wine bottle. The edges of the re-attachable container identifiers 915 include perforations 910 that allow the re-attachable container identifiers 915 to be more easily removed. The re-attachable container identifiers 915 also include text 920 that serves to identify the producer, vintage, or other information about the wine, once attached to a glass.

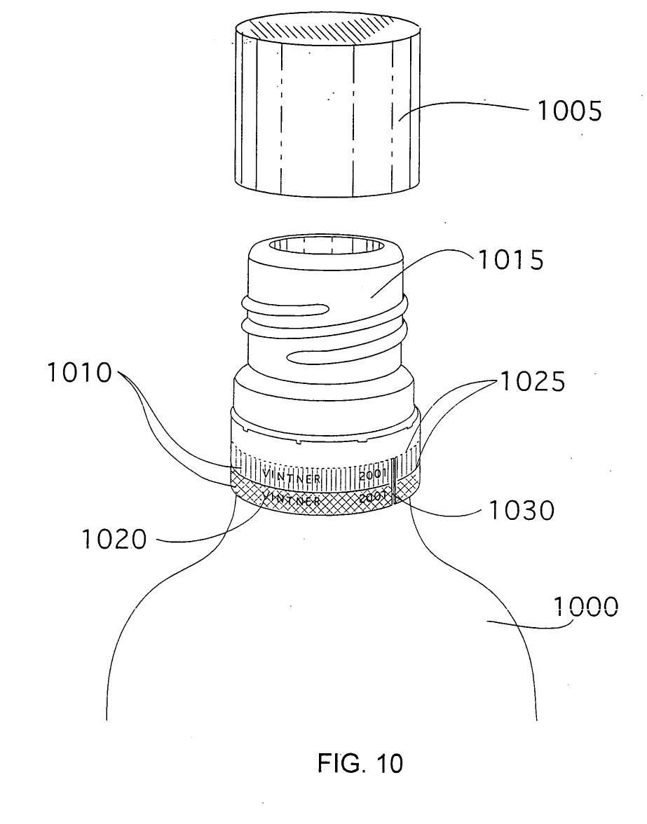

FIG. 10 is an illustration in perspective view of another embodiment of the present invention prior to being removed from a wine bottle. A wine bottle 1000 is shown with a screw cap 1005 that is removed from the bottle cap 1015. Several color coded re-attachable container identifiers 1010 are attached to the neck of the bottle and include text 1020 indicating the producer and vintage of the wine. When removed and attached to a wine glass, these will allow one to distinguish his or her glass among others while identifying the producer and vintage of the wine in the glass. The re-attachable container identifiers also include perforations 1025 and a slit 1030 to allow them to be more easily removed from the bottle.

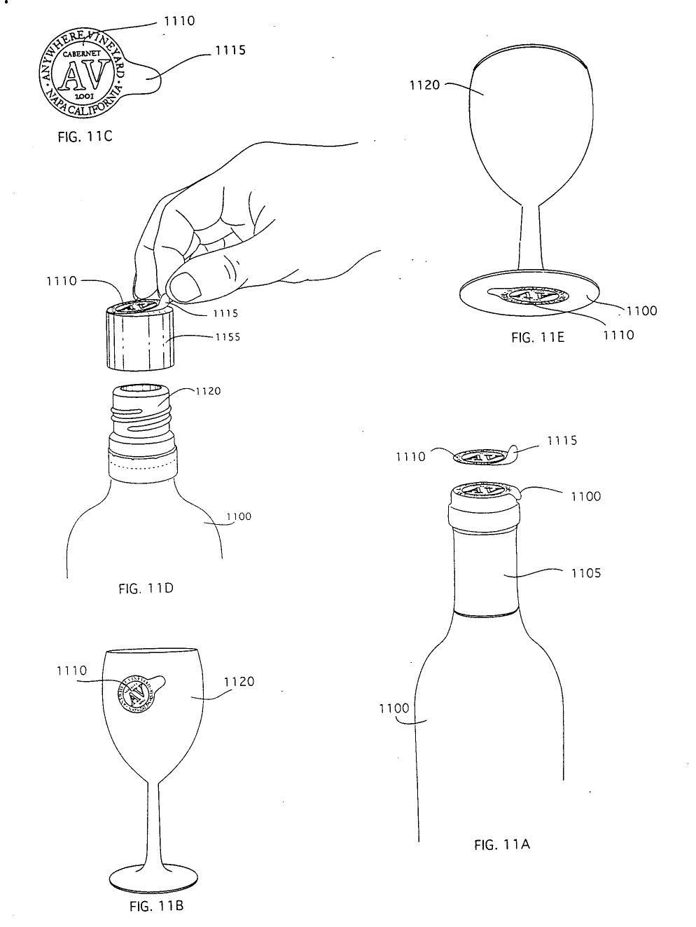

FIG. 11A is an illustration in perspective view of another embodiment of the present invention while attached and when removed from a wine bottle. A wine bottle 1100 is shown with a re-attachable container identifier 1110 still attached to the top of the bottle, above the capsule 1105. Above the bottle is shown a re-attachable container identifier 1110 with a tab 1115 extending outwards to facilitate easier handling of the re-attachable container identifier 1110.

FIG. 11B is an illustration in perspective view of another embodiment of the present invention while attached to the side of a wine glass. A wine glass 1120 is shown with a re-attachable container identifier 1110 attached to its side.

FIG. 11C is an illustration of another embodiment of the present invention. A re-attachable container identifier 1110 is shown with text that indicates the producer and vintage of the wine and a tab 1115 to facilitate easier handling of the re-attachable container identifier 1110.

FIG. 11D is an illustration in perspective view of another embodiment of the present invention while being removed from a screw-cap type wine bottle. A wine bottle 1100 is shown with the screw cap 1125 removed from the bottle cap 1120. The top of the screw cap 1125 includes a re-attachable container identifier 1110 which is being removed by handling the tab 1115.

FIG. 11E is an illustration in perspective view of another embodiment of the present invention while attached to the underside of a wine glass. A wine glass 1120 is shown with a re-attachable container identifier 1110 attached to its underside, as is practiced in a “blind tasting.”

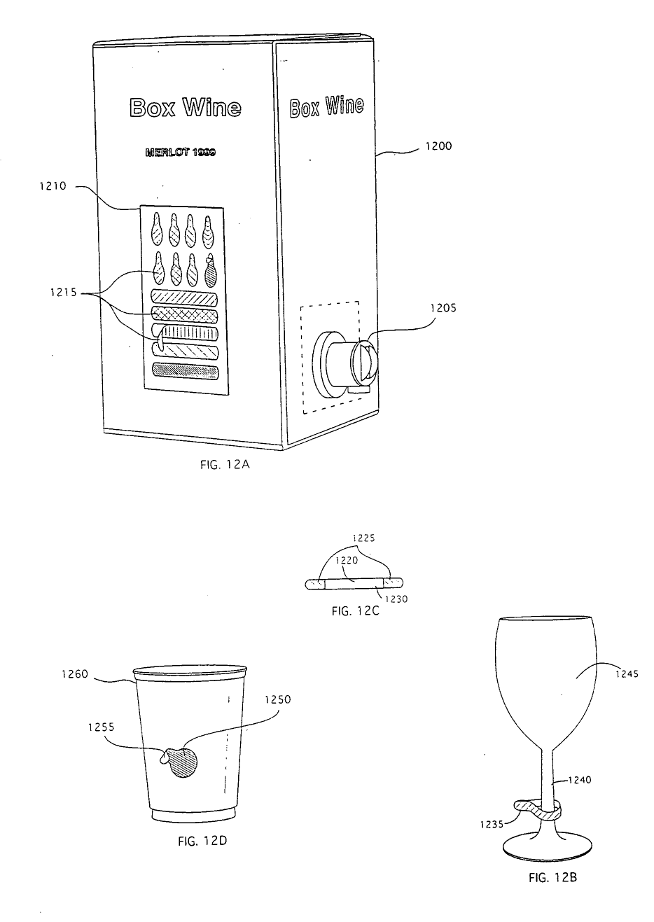

FIG. 12A is an illustration in perspective view of another embodiment of the present invention while attached to a box of wine. A box of wine 1200 and spigot 1205 are shown with a label card 1210, containing re-attachable container identifiers 1215, attached to the side of the box.

FIG. 12B is an illustration in perspective view of another embodiment of the present invention while attached to a wine glass. A label 1235 affixed to the stem 1240 of a wine glass 1245 is shown. The front of the label is facing outwards, allowing one to observe the color of the label or any words printed thereon.

FIG. 12C is an illustration in detail of the back of one of the labels from one embodiment of the present invention. The back of a removable label 1230 features two sticky portions 1225 at either end of the label. The middle portion 1220 of the label is not sticky, so as not to attach to the stem of a wine glass.

FIG. 12D is an illustration in perspective view of another embodiment of the present invention while attached to a cup. A re-attachable container identifier 1250 is attached to the side of the cup 1260 with its tab 1255, which facilitates easier handling, exposed.

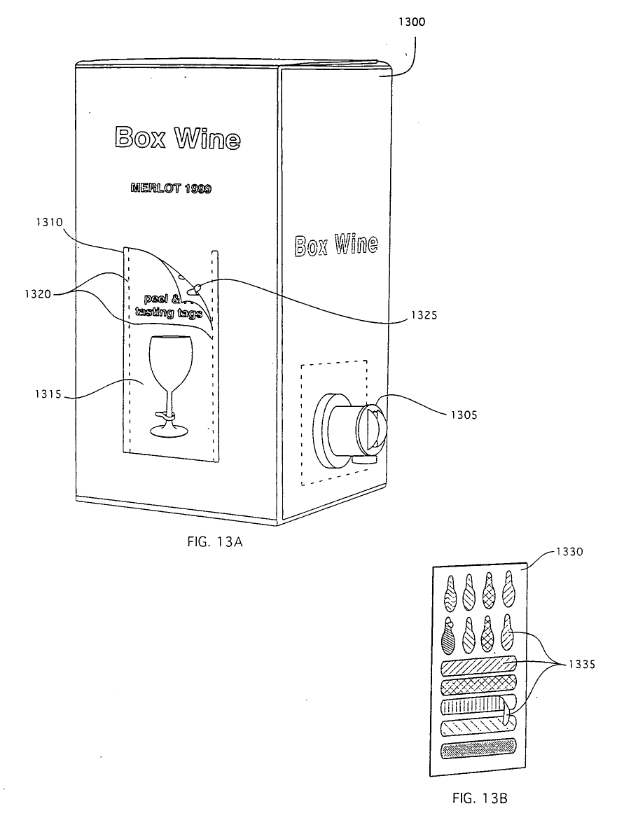

FIG. 13A is an illustration in perspective view of another embodiment of the present invention while attached to a box of wine. A box of wine 1300 with its spigot 1305 is shown with an inwards facing label card 1310 attached to the side of the box 1300. Two vertical perforations 1320 allow the user to remove the label card 1310 from the box 1300. The outside of the label card 1315 may include a graphic diagram or instructions, while the inside of the label card includes the re-attachable container identifiers.

FIG. 13B is an illustration in perspective view of the inside of the label card, another embodiment of the present invention. The label card 1330 includes a variety of shapes and sizes of re-attachable container identifiers 1335, which can feature different colors or text.

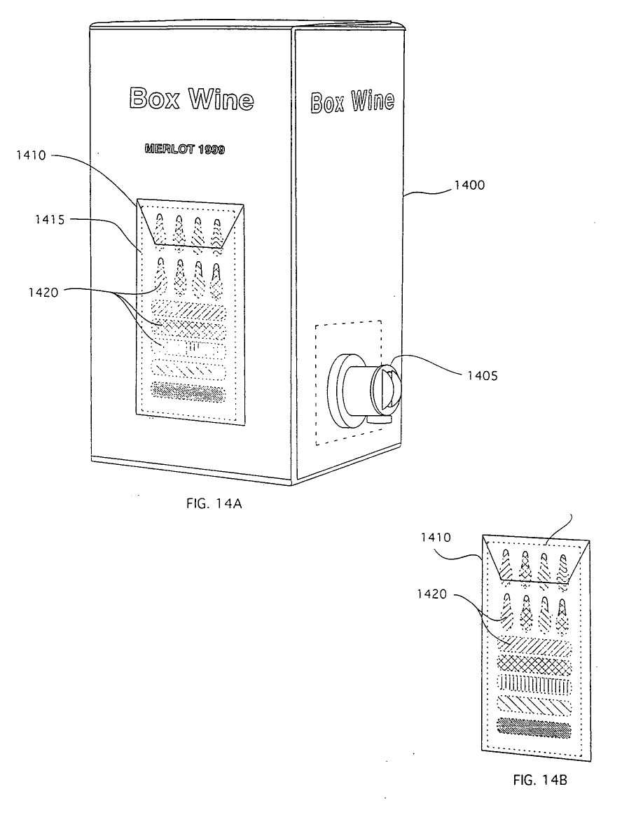

FIG. 14A is an illustration in perspective view of another embodiment of the present invention while attached to a box of wine. A box of wine 1400 is shown with its spigot 1405, an envelope 1410 attached, containing a label card 1415 with numerous re-attachable container identifiers 1420.

FIG. 14B is an illustration in perspective view of the envelope and label card of another embodiment of the present invention. An envelope 1410 is shown with a label card 1415 with numerous re-attachable container identifiers 1420. The envelope 1410 serves to protect the label card 1415 during shipment and storage of the box of wine.

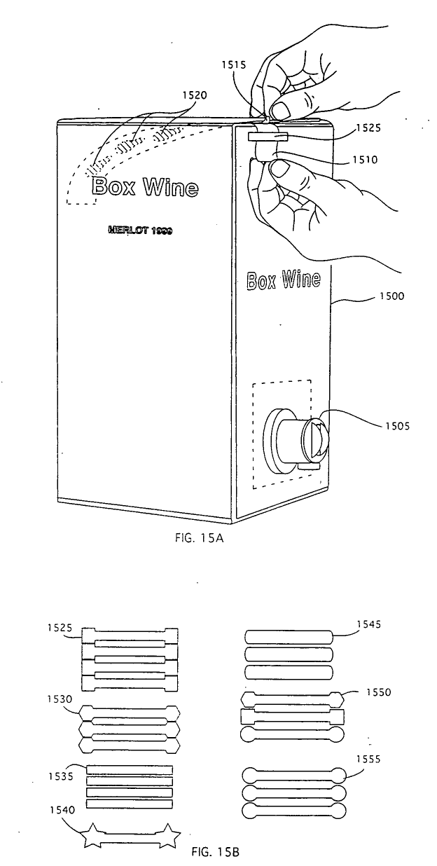

FIG. 15A is an illustration in perspective view of another embodiment of the present invention while attached to a box of wine. A box of wine 1500 is shown with a leader tape 1510 that attaches several re-attachable container identifiers 1520. As shown in the diagram, the user may pull on the leader tape 1510 to expose re-attachable container identifiers 1520 and remove individual re-attachable container identifiers 1520 by pulling on their tabs 1515. The leader tape 1510 passes under a paper or cardboard lug 1525, which forces the leader tape 1510 to make a 90-degree turn and, thereby, facilitates easier removal of the re-attachable container identifiers 1520.

FIG. 15B is an illustration of several of the varieties of label shapes that may be used in conjunction with the various embodiments of the present invention. Dumbbell shaped labels with square ends are marked as 1525. Dumbbell shaped labels with octagonal ends marked as 1530. Rectangle shaped labels are marked as 1535. A dumbbell shaped label with star shaped ends is marked as 1540. Oval shaped labels are marked as 1545. Dumbbell shaped labels with varying shaped ends are marked as 1550. Dumbbell shaped labels with circular ends are marked as 1555.

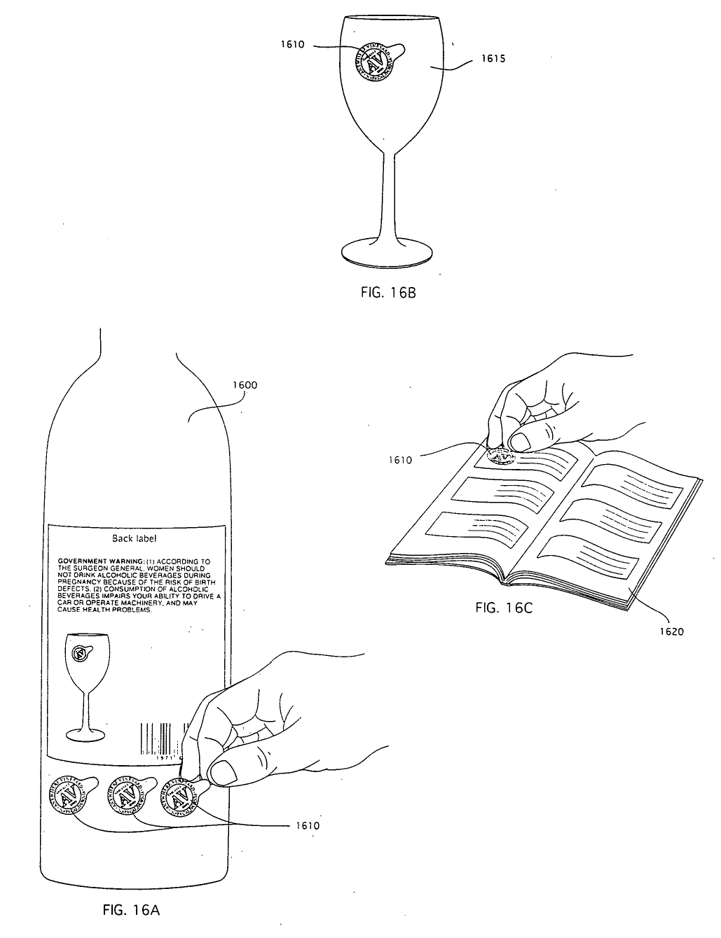

FIG. 16A is an illustration in perspective view of another embodiment of the present invention while attached to a box of wine. The back of a wine bottle 1600 is shown with several re-attachable container identifiers 1610 attached and the user removing one of the re-attachable container identifiers 1610.

FIG. 16B is an illustration in perspective view of another embodiment of the present invention while attached to a wine glass. A wine glass 1615 is shown with a re-attachable container identifier 1610 attached to its side.

FIG. 16C is an illustration in perspective view of another embodiment of the present invention while being attached to a wine diary. A wine diary 1620 is shown with the user placing a re-attachable container identifier 1610 onto its pages. The user is, thus, able to keep the re-attachable container identifier 1610 after it was attached to his or her glass in order to maintain a log of the wines tasted.

FIG. 17A is an illustration in perspective view of another embodiment of the present invention while attached to a bottle of wine. As shown in FIG. 17A, a wine bottle 1700 can hold a label cylinder 1705 containing several individual labels 1710 on the neck 1715 of the wine bottle 1700. The label cylinder 1705 can operate in a similar fashion as those of other embodiments in order to designate the wine type and distinguish the taster's glass and to include diagrams or instructions 1720 on the use of re-attachable container identifiers. Also, the label cylinder can be used in conjunction with more re-attachable container identifiers 1730 on the back label 1720 of a wine bottle 1700.

FIG. 17B is an illustration in perspective view of another embodiment of the present invention while attached to a bottle of wine. As shown in FIG. 17B, a wine bottle 1700 can hold a label cone 1705 containing several individual labels 1710 on the neck 1715 of the wine bottle 1700. The label cone 1705 can operate in a similar fashion as those of other embodiments in order to designate the wine type and distinguish the taster's glass and to include diagrams or instructions 1720 of the use of re-attachable container identifiers. Also, the label cylinder can be used in conjunction with more re-attachable container identifiers 1730 on the back label 1725 of a wine bottle 1700.

We claim:

1. A product for identifying substances transferred into a smaller container from a larger container, comprising,
a container with a label, the label being removable,
the label including identifying words, symbols, marks, and/or colors,
the label being removed from the larger container and affixed to the smaller container into which the substance is poured,
the label serving to identify the type or source of the substance.

2. A product for distinguishing among smaller containers into which substances are transferred from a larger container, comprising,
a container with labels, the labels being removable,
each label being distinguishable by color, pattern, or other identifying feature,
the labels being removed from the larger container and affixed to the smaller containers into which the substance is poured,
the label serving to distinguish among the different smaller containers into which the substance is poured.

3. A product for identifying substances poured into a smaller container from a larger container according to claim 1, wherein the larger container includes labels of different colors that can be used to distinguish between the smaller containers into which the substance is poured and information to identify the source or type of substance.

4. A product for identifying substances poured into smaller containers from a larger container according to claim 1, wherein the larger container is a wine bottle, the smaller containers are wine glasses, and the substance is wine.

5. A product for distinguishing among smaller containers into which substances are poured according to claim 2, wherein the larger container is a wine bottle, the smaller containers are wine glasses, and the substance is wine.

6. A product for identifying substances and distinguishing smaller containers according to claim 3, wherein the larger container is a wine bottle, the smaller containers are wine glasses, and the substance is wine.

7. A product for identifying wine poured into wine glasses according to claim 4, wherein the removable labels are derived from the capsule of the wine bottle and affixed to the wine glasses.

8. A product for distinguishing wine glasses into which wine is poured according to claim 5, wherein the removable labels are derived from the capsule of the wine bottle and affixed to the wine glasses.

9. A product for identifying wine and distinguishing wine glasses according to claim 6, wherein the removable labels are derived from the capsule of the wine bottle and affixed to the wine glasses.

10. A product for identifying wine poured into wine glasses according to claim 7, wherein the capsule is color coded on its inside surface so as not to change the standard look of the capsule.

11. A product for distinguishing wine glasses into which wine is poured according to claim 8, wherein the capsule is color coded on its inside surface so as not to change the standard look of the capsule.

12. A product for identifying wine and distinguishing wine glasses according to claim 9, wherein the capsule is color coded on its inside surface so as not to change the standard look of the capsule.

13. A product for identifying wine poured into wine glasses according to claim 4, wherein the removable labels are flexible rings that are packaged beneath the capsule of a wine bottle.

14. A product for distinguishing wine glass into which wine is poured according to claim 5, where the removable labels are flexible rings that are packaged beneath the capsule of a wine bottle.

15. A product for identifying wine and distinguishing wine glasses according to claim 6, wherein the removable labels are flexible rings that are packaged beneath the capsule of a wine bottle.

16. A product for identifying wine poured into wine glasses according to claim 7, wherein the capsule of the wine bottle includes a pull ring to facilitate easy removal of the capsule and separation of the labels.

17. A product for distinguishing wine glass into which wine is poured according to claim 8, wherein the capsule of the wine bottle includes a pull ring to facilitate easy removal of the capsule and separation of the labels.

18. A product for identifying wine and distinguishing wine glasses according to claim 9, wherein the capsule of the wine bottle includes a pull ring to facilitate easy removal of the capsule and separation of the labels.

19. A product for identifying wine poured into wine glasses according to claim 4, wherein removable labels are included on one of the several bottle labels included with a bottle of wine.

20. A product for distinguishing wine glass into which wine is poured according to claim 5, wherein removable labels are included on one of the several bottle labels included with a bottle of wine.

21. A product for identifying wine and distinguishing wine glasses according to claim 6, wherein removable labels are included on one of the several bottle labels included with a bottle of wine.

22. A product for identifying wine poured into wine glasses according to claim 4, wherein the labels are included as part of a label card that can be packaged along with the wine bottle.

23. A product for distinguishing wine glass into which wine is poured according to claim 5, wherein the labels are included as part of a label card that can be packaged along with the wine bottle.

24. A product for identifying wine and distinguishing wine glasses according to claim 6, wherein the labels are included as part of a label card that can be packaged along with the wine bottle.

25. A product for identifying wine poured into wine glasses according to claim 4, wherein the cameo attached to the wine bottle is used to label the wine glasses.

26. A product for distinguishing wine glass into which wine is poured according to claim 5, wherein the cameos attached to the wine bottle are used to label the wine glasses.

27. A product for identifying wine and distinguishing wine glasses according to claim 6, wherein the cameos attached to the wine bottle are used to label the wine glasses.

28. A product for identifying wine poured into wine glasses according to claim 4, wherein re-attachable container identifiers are integrated to the capsule of a screw cap type wine bottle.

29. A product for distinguishing wine glass into which wine is poured according to claim 5, wherein re-attachable container identifiers are attached to the neck of a screw cap type wine bottle.

30. A product for identifying wine and distinguishing wine glasses according to claim 6, wherein the re-attachable container identifiers are integrated to the capsule of screw cap type wine bottle.

31. A product for identifying wine and distinguishing wine glasses according to claim 6, wherein the re-attachable container identifiers are attached to the neck of a screw cap type wine bottle.

32. A product for identifying wine poured into wine glasses according to claim 4, wherein the removable label is derived from the top of the capsule of the wine bottle and affixed to the wine glass.

33. A product for distinguishing wine glasses into which wine is poured according to claim 5, wherein the removable label is derived from the top of the capsule of the wine bottle and affixed to the wine glass.

34. A product for identifying wine and distinguishing wine glasses according to claim 6, wherein the removable label is derived from the top of the capsule of the wine bottle and affixed to the wine glass.

35. A product for identifying wine poured into wine glasses according to claim 22, wherein the label card is delivered attached to the side of a box of wine.

36. A product for distinguishing wine glasses into which wine is poured according to claim 23, wherein the label card is delivered attached to the side of a box of wine.

37. A product for identifying wine and distinguishing wine glasses according to claim 24, wherein the label card is delivered attached to the side of a box of wine.

38. A product for identifying wine poured into wine glasses according to claim 22, wherein the label card is delivered attached to the side of a box of wine with the labels delivered facing inwards and the label card removable from the box to expose the labels.

39. A product for distinguishing wine glasses into which wine is poured according to claim 23, wherein the label card is delivered attached to the side of a box of wine with the labels facing delivered inwards and the label card removable from the box to expose the labels.

40. A product for identifying wine and distinguishing wine glasses according to claim 24, wherein the label card is delivered attached to the side of a box of wine with the labels delivered facing inwards and the label card removable from the box to expose the labels.

41. A product for identifying wine poured into wine glasses according to claim 22, wherein the label card is delivered in an envelope attached to the side of a box of wine.

42. A product for distinguishing wine glasses into which wine is poured according to claim 23, wherein the label card is delivered in an envelope attached to the side of a box of wine.

43. A product for identifying wine and distinguishing wine glasses according to claim 24, wherein the label card is packaged delivered in an envelope attached to the side of a box of wine.

44. A product for identifying substances poured into smaller containers from a larger container according to claim 1, wherein the larger container includes a removable leader tape, the leader tape holding the labels.

45. A product for distinguishing among smaller containers into which substances are poured according to claim 2, wherein the larger container includes a removable leader tape, the leader tape holding the labels.

46. A product for identifying substances and distinguishing smaller containers according to claim 3, wherein the larger container includes a removable leader tape, the leader tape holding the labels.

47. A product for identifying substances poured into smaller containers from a larger container according to claim 44, wherein the larger container is a box of wine, the smaller containers are wine glasses, and the substance is wine.

48. A product for distinguishing among smaller containers into which substances are poured according to claim 45, wherein the larger container is a box of wine, the smaller containers are wine glasses, and the substance is wine.

49. A product for identifying substances and distinguishing smaller containers according to claim 46, wherein the larger container is a box of wine, the smaller containers are wine glasses, and the substance is wine.

50. A product for identifying substances poured into smaller containers from a larger container according to claim 1, wherein the label can be maintained by the user in a book or diary in order to maintain a log of the substances in the larger container.

51. A product for distinguishing among smaller containers into which substances are poured according to claim 2, wherein the label can be maintained by the user in a book or diary in order to maintain a log of the substances in the larger container.

52. A product for identifying substances and distinguishing smaller containers according to claim 3, wherein the label can be maintained by the user in a book or diary in order to maintain a log of the substances in the larger container.

53. A product for identifying wine poured into wine glasses according to claim 4, wherein the labels are included as part of a label cylinder that can be packaged along with the wine bottle and wraps around the neck of the wine bottle.

54. A product for distinguishing wine glass into which wine is poured according to claim 5, wherein the labels are included as part of a label cylinder that can be packaged along with the wine bottle and wraps around the neck of the wine bottle.

55. A product for identifying wine and distinguishing wine glasses according to claim 6, wherein the labels are included as part of a label cylinder that can be packaged along with the wine bottle and wraps around the neck of the wine bottle.

56. A product for identifying wine poured into wine glasses according to claim 4, wherein the labels are included as part of a label cone that can be packaged along with the wine bottle and wraps around the neck of the wine bottle.

57. A product for distinguishing wine glass into which wine is poured according to claim 5, wherein the labels are included as part of a label cone that can be packaged along with the wine bottle and wraps around the neck of the wine bottle.

58. A product for identifying wine and distinguishing wine glasses according to claim 6, wherein the labels are included as part of a label cone that can be packaged along with the wine bottle and wraps around the neck of the wine bottle.
